(19) United States
(12) Patent Application Publication
(10) Pub. No.: US 2013/0208020 A1
(43) Pub. Date: Aug. 15, 2013

(54) DISPLAY APPARATUS AND METHOD OF DISPLAYING THREE-DIMENSIONAL IMAGE USING THE SAME

(71) Applicants: Kyung-Ho JUNG, Yongin-si (KR); Jin-Hwan KIM, Suwon-si (KR); Kyung-Bae KIM, Yongin-si (KR); Soo-Hee OH, Gunpo-si (KR); Ki-Kyung YOUK, Bucheon-si (KR); Yong-Cheol JEONG, Yongin-si (KR)

(72) Inventors: Kyung-Ho JUNG, Yongin-si (KR); Jin-Hwan KIM, Suwon-si (KR); Kyung-Bae KIM, Yongin-si (KR); Soo-Hee OH, Gunpo-si (KR); Ki-Kyung YOUK, Bucheon-si (KR); Yong-Cheol JEONG, Yongin-si (KR)

(73) Assignee: SAMSUNG DISPLAY CO., LTD., Yongin-City (KR)

(21) Appl. No.: 13/560,475

(22) Filed: Jul. 27, 2012

(30) Foreign Application Priority Data
Feb. 14, 2012 (KR) 10-2012-0014924

(51) Int. Cl. G09G 5/10

(52) U.S. Cl. 345/690

(57) ABSTRACT

A display apparatus includes a display panel including a three-dimensional (“3D”) pixel, including multiple subpixels corresponding to multiple viewpoints, a viewpoint detecting part configured to detect a target viewpoint, a display panel driver configured to generate grayscale data of the subpixels based on the detected target viewpoint, and a light converting element including a light converting axis sequentially corresponding to central regions of the subpixels including colors different from one another And configured to convert an image on the display panel into a 3D image.

### CROSS-REFERENCE TO RELATED APPLICATION

This application claims priority from and benefit of Korean Patent Application No. 10-2012-0014924, filed on Feb. 14, 2012, and all the benefits accruing therefrom under 35 U.S.C. §119, the contents of which are herein incorporated by reference in their entireties.

### BACKGROUND

1. Field

The following description relates to a display apparatus and a method for displaying a three-dimensional (“3D”) image using the display apparatus.

2. Discussion of the Background

Generally, a display apparatus displays a two-dimensional (“2D”) image. Recently, as a demand for displaying a 3D image have been increasing in video game and movie industries, the display apparatus has been developed to display the 3D image.

Generally, a stereoscopic image display apparatus may display the 3D image using a binocular parallax between two eyes of a human. For example, as two eyes of a human are spaced apart from each other, images viewed at different angles may be inputted to a human brain. The human brain mixes the images so that a viewer may recognize the 3D image.

The stereoscopic image display apparatus may be divided into a stereoscopic type and an auto-stereoscopic type based on whether a viewer needs glasses to see the 3D image. The stereoscopic type may include an anaglyph type and a shutter glass type and the like. The auto-stereoscopic type may include a lenticular type, a barrier type, a liquid crystal lens type, and a liquid crystal barrier type.

The auto-stereoscopic type display apparatus may generate a plurality of images having various viewpoints. When the number of the viewpoints increases, a display area of the 3D image increases. However, a resolution of the 3D image decreases.

In the stereoscopic display apparatus operating a subpixel rendering method, when a position of the viewpoint and a position of a rendered image by the subpixel rendering method are misaligned so that primary colors may not be appropriately mixed, a color breakup, in which a primary color may be shown to a viewer, may occur.

### SUMMARY

Exemplary embodiments of the present invention provide a display apparatus to improve a display quality of a three-dimensional (“3D”) image.

Exemplary embodiments of the present invention also provide a method for displaying the 3D image using the display apparatus.

Additional features of the invention will be set forth in the description which follows, and in part will be apparent from the description, or may be learned by practice of the invention.

An exemplary embodiment of the present invention provide a display panel including a first three-dimensional (“3D”) pixel, a second 3D pixel, and a third 3D pixel, wherein each 3D pixel includes a first subpixel, a second subpixel, and a third subpixel corresponding to a plurality of viewpoints; a viewpoint detecting part configured to detect a target viewpoint; a display panel driver configured to generate grayscale data of the subpixels based on the target viewpoint; and a light converting element including a light converting axis sequentially corresponding to central regions of the subpixels including colors different from one another and configured to convert an image on the display panel into a 3D image.

An exemplary embodiment of the present invention includes detecting a target viewpoint, generating grayscale data for a first subpixel, a second subpixel, and a third subpixel corresponding to multiple viewpoints based on the target viewpoint, and converting an image on a display panel into a 3D image using a light converting element comprising a light converting axis sequentially corresponding to central regions of the subpixels comprising colors different from one another.

An exemplary embodiment of the present invention provides a display panel including a display panel comprising a three-dimensional (“3D”) pixel, the 3D pixel including a plurality of subpixels comprising different colors; a viewpoint detecting part configured to detect a target viewpoint; and a display panel driver configured to generate grayscale data of the subpixels based on the target viewpoint, in which the target viewpoint corresponds to a light converting axis passing through central regions of at least three subpixels of different colors.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a display apparatus according to an exemplary embodiment of the present invention.

FIG. 2 is a plan view illustrating a pixel structure of the display panel of FIG. 1.

FIG. 3 is a graph illustrating an intensity of a light passing the subpixel of FIG. 2 with respect to viewpoints if same data voltage is applied to the subpixels corresponding to each of the viewpoints according to an exemplary embodiment of the present invention.

FIG. 4 is a block diagram illustrating a display panel driver of FIG. 1.

FIG. 5 is a plan view illustrating a pixel structure of a display panel according to an exemplary embodiment of the present invention.

FIG. 6 is a plan view illustrating a pixel structure of a display panel according to an exemplary embodiment of the present invention.

FIG. 7 is a graph illustrating an intensity of a light passing the subpixel of FIG. 6 with respect to viewpoints if same data voltage is applied to the subpixels corresponding to each of the viewpoints according to an exemplary embodiment of the present invention.

FIG. 8 is a plan view illustrating a pixel structure of a display panel according to an exemplary embodiment of the present invention.

FIG. 9 is a plan view illustrating a pixel structure of a display panel according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Further, it will be understood that when an element is referred to as being “on” or “connected to” or “coupled to” another element, it can be directly on, directly connected to, or directly coupled to the other element, or intervening elements may be present. In contrast, if an element is referred to as being “directly on” or “directly connected to” or “directly coupled to” another element, no intervening elements are present.

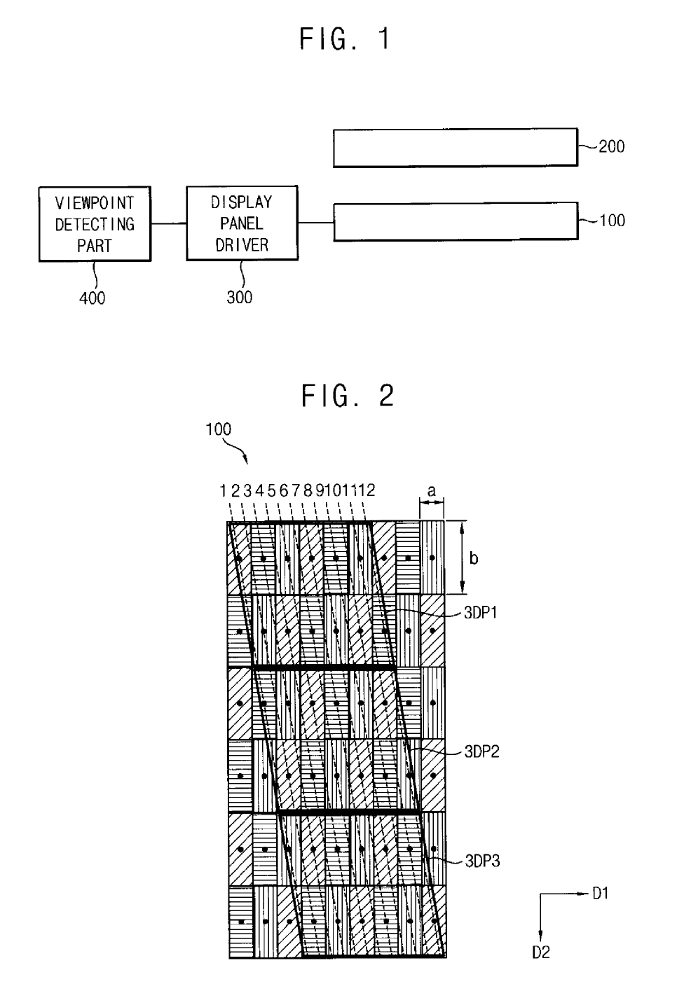

FIG. 1 is a block diagram illustrating a display apparatus according to an exemplary embodiment of the present invention.

Referring to FIG. 1, the display apparatus includes a display panel 100, a light converting element 200, a display panel driver 300 and a viewpoint detecting part 400.

The display panel 100 may display an image. The display panel 100 may include a first substrate, a second substrate facing the first substrate and a liquid crystal layer disposed between the first substrate and the second substrate.

The display panel 100 may include a plurality of gate lines, a plurality of data lines and a plurality of pixels connected to the gate lines and the data lines.

The pixel may include a switching element and a liquid crystal capacitor electrically connected to the switching element. The pixel may further include a storage capacitor.

The gate lines, the data lines, pixel electrodes and storage electrodes may be disposed on the first panel substrate. A common electrode may be disposed on the second panel substrate.

The display panel 100 may display a 2D image in a 2D mode. The display panel 100 may display a 3D image in a 3D mode.

A pixel structure of the display panel 100 is described in more detail with io reference to FIG. 2.

The light converting element 200 may be disposed on the display panel 100. The light converting element 200 may convert the 2D image on the display panel 100 into the 3D image. For example, the light converting element 200 may transmit the image on a subpixel of the display panel 100 to various viewpoints.

The light converting element 200 may include a light converting axis. The light converting axis may be inclined or oriented at an angle to have a slope with respect to the data line of the display panel.

For example, the light converting element 200 may include a plurality of lenticular lenses. The lenticular lenses may refract the image on the subpixel of the display panel 100 to the various viewpoints. The lenticular lenses may be disposed in a first direction. The lenticular lenses may extend in a second direction crossing the first direction. Alternatively, the lenticular lenses may extend in an angular direction with respect to the second direction. The light converting axis may be similar or substantially equal to a lens axis of the lenticular lens, which may be an extending direction of the lenticular lens.

For example, the light converting element 200 may include a plurality of barriers. The barriers may selectively block the image on the subpixel of the display panel 100 so that the image on the display panel 100 may be transmitted to the various viewpoints. The barriers may be disposed in the first direction. The barriers may extend in the second direction crossing the first direction. Alternatively, the barriers may extend in an angular direction with respect to the second direction. The light converting axis may be similar or substantially equal to a barrier axis, which may be an extending direction of the barrier.

For example, the light converting element 200 may be a lens module, which may be operated according to a driving mode including the 2D mode and the 3D mode. For example, the light converting element 200 may be a liquid crystal lens module. The lens module may be turned on or off in response to the driving mode. For example, the lens module may be turned off in the 2D mode so that the display apparatus displays the 2D image. The lens module may be turned on in the 3D mode so that the display apparatus displays the 3D image.

The lens module may include a first lens substrate, a second lens substrate facing the first lens substrate and a lens liquid crystal layer disposed between the first substrate and the second lens substrate.

In the 3D mode, the lens module may include a plurality of unit lenses, which may operate as the lenticular lenses. The unit lenses may refract the image on the subpixel of the display panel 100 to the various viewpoints. Herein, the light converting axis may be similar or substantially equal to a lens axis of the unit lens, which may be an extending direction of the unit lens.

For example, the unit lens may be a Fresnel lens including a plurality of divided lens areas, but is not limited thereto. Each of the lens areas may include a plurality of lens electrodes.

For example, the light converting element 200 may be a barrier module, which may be operated according to the driving mode including the 2D mode and the 3D mode. For example, the light converting element 200 may be a liquid crystal barrier module. The barrier module may be turned on or off in response to the driving mode. For example, the barrier module may be turned off in the 2D mode so that the display apparatus displays the 2D image. The barrier module may be turned on in the 3D mode so that the display apparatus displays the 3D image.

The barrier module may include a first barrier substrate, a second barrier substrate facing the first barrier substrate and a barrier liquid crystal layer disposed between the first substrate and the second barrier substrate.

In the 3D mode, the barrier module may include a plurality of unit barriers which may operate as barriers. The unit barriers may selectively block the image on the subpixel of the display panel 100 so that the image on the subpixel of the display panel 100 may be transmitted to the various viewpoints. Herein, the light converting axis may be similar or substantially equal to a unit barrier axis, which may be an extending direction of the unit barrier.

Alternatively, the light converting element 200 may include a plurality of prisms that may change a path of the light. Alternatively, the light converting element 200 may include a holographic element that may change a path of the light.

The display panel driver 300 is connected to the display panel 100 to drive the display panel 100.

The display panel driver 300 may receive viewer's viewpoint data from the viewpoint detecting part 400. The display panel driver 300 may generate grayscale data of the subpixels of the display panel 100 based on the viewpoint data. The display panel driver 300 may generate gate signals to drive the gate lines of the display panel 100, and output the gate signals to the gate lines. The display panel driver 300 may generate data voltages to drive the data lines of the display panel 100 based on the grayscale data of the subpixels, and outputs the data voltages to the data lines.

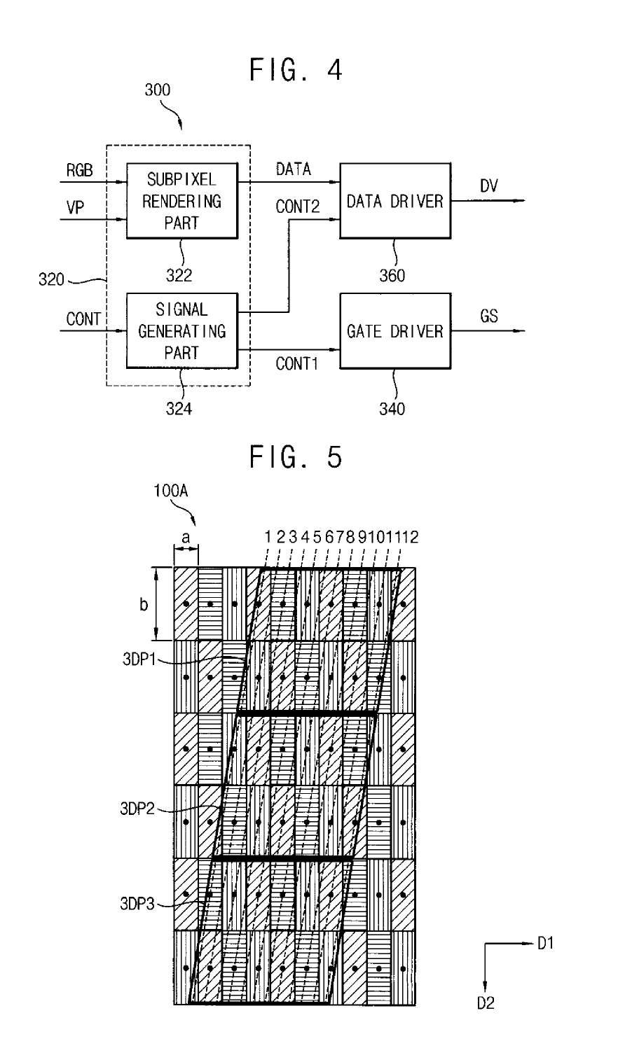

Elements of the display panel driver 300 are described in more detail with reference to FIG. 4.

The viewpoint detecting part 400 may detect positions of a left eye and a right eye of the viewer. The viewpoint detecting part 400 may determine the viewer's viewpoint based on the positions of the left eye and the right eye of the viewer. The viewer's viewpoint may be a target viewpoint. The viewpoint detecting part 400 may output the viewer's viewpoint to the display panel driver 300.

Further, the viewpoint detecting part 400 may detect a looking direction of the viewer's eyes to determine the viewer's viewpoint.

For example, the viewpoint detecting part 400 may include, without limitation, a camera or a similar image capturing device. The viewpoint detecting part 400 may be disposed on a bezel of a receiving container of the display panel 100, but is not limited thereto.

FIG. 2 is a plan view illustrating a pixel structure of the display panel 100 of FIG. 1.

Referring to FIG. 2, the display panel 100 includes a plurality of subpixels. The subpixels are disposed in a matrix form.

For example, one or more subpixels may have a rectangular shape. The subpixel may have a first side oriented in a first direction D1, which may be shorter in comparison to a second side oriented in a second direction D2. The first side may be shorter than a first reference length, and the second side may be longer than a second reference length.

The display panel 100 may include a first color subpixel having a first color, a second color subpixel having a second color different from the first color, and a third color subpixel having a third color different from the first color and the second color.

In FIG. 2, a rectangular shape with a plurality of diagonal lines represents the first color subpixel, a rectangular shape with a plurality of horizontal lines represents the second color subpixel, and a rectangular shape with a plurality of vertical lines represents the third color subpixel.

For example, the first color may be red. The second color may be green. The third color may be blue.

The display panel 100 includes a plurality of 3D pixels 3DP1, 3DP2 and 3DP3. The subpixels in each of the 3D pixels 3DP1, 3DP2 and 3DP3 may respectively correspond to is viewpoints different from one another.

The number of the viewpoints of the display apparatus may be a positive integer equal to or greater than six. In an example, the display apparatus may include twelve viewpoints to display the 3D image. Accordingly, each of the 3D pixels 3DP1, 3DP2 and 3DP3 may include twelve subpixels respectively corresponding to twelve viewpoints.

The directions of the viewpoints 1 to 12 may be similar or substantially equal to the light converting axis of the light converting element 200. The viewpoints 1 to 12 may pass through central points or regions of the subpixels in the 3D pixels 3DP1, 3DP2 and 3DP3. In an example, a viewpoint 1 may pass through a central point or region of a red subpixel in the 3DP1, a central point or region of a green subpixel in the 3DP2, and a central point or region of a blue subpixel in the 3DP3. The viewpoints 1 to 12 may be disposed with a uniform gap disposed between one another. A first subpixel may include a color different from a color of a second subpixel, which may correspond to an adjacent viewpoint.

For example, a first 3D pixel 3DP1 may have twelve subpixels disposed in a substantially parallelogrammic shape. In the first 3D pixel 3DP1, a subpixel corresponding to a first viewpoint 1 may have the first color, a subpixel corresponding to a second viewpoint 2 adjacent to the first viewpoint 1 may have the third color, a subpixel corresponding to a third viewpoint 3 adjacent to the second viewpoint 2 may have the second color, a subpixel corresponding to a fourth viewpoint 4 adjacent to the third viewpoint 3 may have the first color, a subpixel corresponding to a fifth viewpoint 5 adjacent to the fourth viewpoint 4 may have the third color, a subpixel corresponding to a sixth viewpoint 6 adjacent to the fifth viewpoint 5 may have the second color, a subpixel corresponding to a seventh viewpoint 7 adjacent to the sixth viewpoint 6 may have the first color, a subpixel corresponding to an eighth viewpoint 8 adjacent to the seventh viewpoint 7 may have the third color, a subpixel corresponding to a ninth viewpoint 9 adjacent to the eighth viewpoint 8 may have the second color, a subpixel corresponding to a tenth viewpoint 10 adjacent to the ninth viewpoint 9 may have the first color, a subpixel corresponding to an eleventh viewpoint 11 adjacent to the tenth viewpoint 10 may have the third color, and a subpixel corresponding to a twelfth viewpoint 12 adjacent to the eleventh viewpoint 11 may have the second color.

The second 3D pixel 3DP2 may be disposed adjacent to the first 3D pixel 3DP1 along the light converting axis. The second 3D pixel 3DP2 may have twelve subpixels disposed in a substantially parallelogrammic shape. In the second 3D pixel 3DP2, a subpixel corresponding to a first viewpoint 1 may have the second color, a subpixel corresponding to a second viewpoint 2 adjacent to the first viewpoint 1 may have the first color, a subpixel corresponding to a third viewpoint 3 adjacent to the second viewpoint 2 may have the third color, a subpixel corresponding to a fourth viewpoint 4 adjacent to the third viewpoint 3 may have the second color, a subpixel corresponding to a fifth viewpoint 5 adjacent to the fourth viewpoint 4 may have the first color, a subpixel corresponding to a sixth viewpoint 6 adjacent to the fifth viewpoint 5 may have the third color, a subpixel corresponding to a seventh viewpoint 7 adjacent to the sixth viewpoint 6 may have the second color, a subpixel corresponding to an eighth viewpoint 8 adjacent to the seventh viewpoint 7 may have the first color, a subpixel corresponding to a ninth viewpoint 9 adjacent to the eighth viewpoint 8 may have the third color, a subpixel corresponding to a tenth viewpoint 10 adjacent to the ninth viewpoint 9 may have the second color, a subpixel corresponding to an eleventh viewpoint 11 adjacent to the tenth viewpoint 10 may have the first color, and a subpixel corresponding to a twelfth viewpoint 12 adjacent to the eleventh viewpoint 11 may have the third color.

The third 3D pixel 3DP3 may be disposed adjacent to the second 3D pixel 3DP2 along the light converting axis. The third 3D pixel 3DP3 may have twelve subpixels disposed in a substantially parallelogrammic shape. In the third 3D pixel 3DP3, a subpixel corresponding to a first viewpoint 1 may have the third color, a subpixel corresponding to a second viewpoint 2 adjacent to the first viewpoint 1 may have the second color, a subpixel corresponding to a third viewpoint 3 adjacent to the second viewpoint 2 may have the first color, a subpixel corresponding to a fourth viewpoint 4 adjacent to the third viewpoint 3 may have the third color, a subpixel corresponding to a fifth viewpoint 5 adjacent to the fourth viewpoint 4 may have the second color, a subpixel corresponding to a sixth viewpoint 6 adjacent to the fifth viewpoint 5 may have the first color, a subpixel corresponding to a seventh viewpoint 7 adjacent to the sixth viewpoint 6 may have the third color, a subpixel corresponding to an eighth viewpoint 8 adjacent to the seventh viewpoint 7 may have the second color, a subpixel corresponding to a ninth viewpoint 9 adjacent to the eighth viewpoint 8 may have the first color, a subpixel corresponding to a tenth viewpoint 10 adjacent to the ninth viewpoint 9 may have the third color, a subpixel corresponding to an eleventh viewpoint 11 adjacent to the tenth viewpoint 10 may have the second color, and a subpixel corresponding to a twelfth viewpoint 12 adjacent to the eleventh viewpoint 11 may have the first color.

The light axis of the light converting element 200 may sequentially correspond to central points or regions of the subpixels having colors different from one another. For example, the first viewpoint 1 passes a central point or region of the first color subpixel in the first 3D pixel 3DP1, a central point or region of the second color subpixel in the second 3D pixel 3DP2, and a central point or region of the third color subpixel in the third 3D pixel 3DP3. For example, the second viewpoint 2 passes a central point or region of the third color subpixel in the first 3D pixel 3DP1, a central point or region of the first color subpixel in the second 3D pixel 3DP2, and a central point or region of the second color subpixel in the third 3D pixel 3DP3.

A subpixel row of the display panel 100 may include the first color subpixel, the second color subpixel, and the third color subpixel alternately disposed with one another. An even-numbered subpixel row of the display panel 100 may be shifted by a width of the subpixel in the first direction D1 with respect to an odd-numbered subpixel row of the display panel 100.

Further, the even-numbered subpixel row of the display panel 100 may be shifted by the width of the subpixel or a reference distance in the first direction D1 with respect to an odd-numbered subpixel row of the display panel 100 in a left direction.

A first subpixel row may include the first color subpixel, the second color subpixel and the third color subpixel, which may be sequentially repeated. A second subpixel row may include the second color subpixel, the third color subpixel, and the first color subpixel, which may be sequentially repeated. A third subpixel row may include the first color subpixel, the second color subpixel, and the third color subpixel, which may be sequentially repeated in a similar or the same manner as the first subpixel row. A fourth subpixel row may include the second color subpixel, the third color subpixel, and the first color subpixel, which may be sequentially repeated in a similar or the same manner as the second subpixel row.

The first color subpixels may be disposed in a zigzag pattern along the second direction D2. The second color subpixels may be disposed in a zigzag pattern along the second direction D2. The third color subpixels may be disposed in a zigzag pattern along the second direction D2.

Referring to FIG. 2, a width of each subpixel in the first direction D1 has a value of a. A width of each subpixel in the second direction D2 has a value of b. For example, a:b may be about 1:3.

Further, an absolute value of an slope or inclination of the light converting axis may be 2b/a. The slope or inclination of the light converting axis may be −2b/a. In an example, if a:b is 1:3, the absolute value of the inclination of the light converting axis may be 6, and the slope inclination of the light converting axis may be −6.

Further, the 3D pixels 3DP1, 3DP2 and 3DP3, which may respectively include twelve subpixels, may have a similar or the same width in the first direction D1 and a similar or the same width in the second direction D2.

In FIG. 2, although subpixels in six rows and nine columns are illustrated, the subpixels represent a portion of the display panel 100. For example, the subpixels in six rows and nine columns may be repeated along the first direction D1 and the second direction D2.

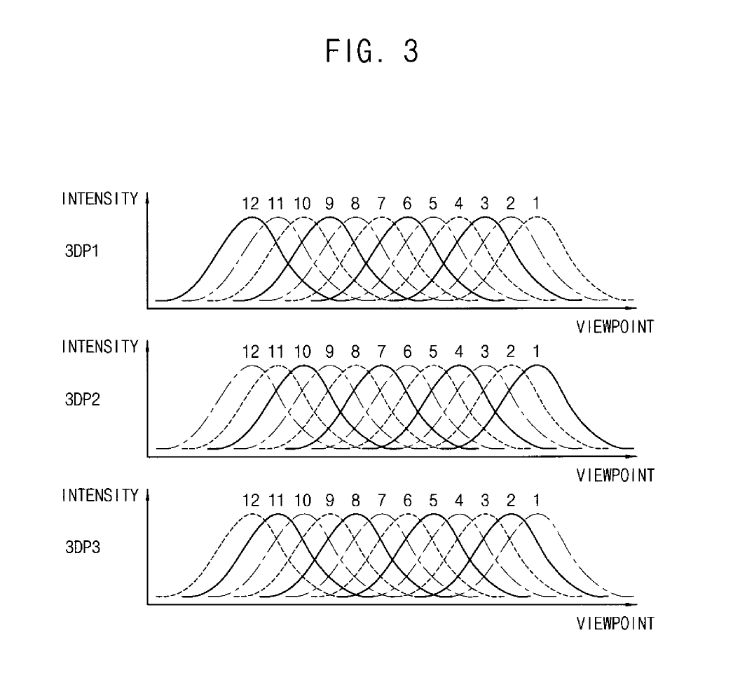

FIG. 3 is a graph illustrating an intensity of a light passing the subpixel of FIG. 2 with respect to viewpoints if same data voltage is applied to the subpixels corresponding to each of the viewpoints according to an exemplary embodiment of the present invention.

In FIG. 3, a dotted line may represent an intensity of light having the first color. A solid line may represent an intensity of light having the second color. A dash-dot line may represent an intensity of light having the third color.

Referring to FIG. 2 and FIG. 3, in the first 3D pixel 3DP1, the first viewpoint 1 may pass the central point or region of the first color subpixel so that the intensity of light having the first color may be above a reference value or strength. Light having the third color is shown at the first viewpoint 1 under influence of the third color subpixel corresponding to the second viewpoint 2. The second color subpixel corresponding to the third viewpoint 3, which may be spaced apart from the first viewpoint 1, may rarely influence the first viewpoint 1. Although not shown in FIG. 3, light having the second color may be shown at the first viewpoint 1 under influence of the second color subpixel corresponding to the twelfth viewpoint 12 of another 3D pixel.

In the first 3D pixel 3DP1, the second viewpoint 2 passes the central point of the third color subpixel so that the intensity of light having the third color may be above a reference value or strength. Light having the first color is shown at the second viewpoint 2 under influence of the first color subpixel corresponding to the first viewpoint 1. Light having the second color is shown at the second viewpoint 2 under influence of the second color subpixel corresponding to the third viewpoint 3. The first color subpixel corresponding to the fourth viewpoint 4 spaced apart from the second viewpoint 2 may rarely influence the second viewpoint 2.

In the first 3D pixel 3DP1, the third viewpoint 3 passes the central point of the second color subpixel so that the intensity of light having the second color may be above a reference value or strength. Light having the third color is shown at the third viewpoint 3 under influence of the third color subpixel corresponding to the second viewpoint 2. Light having the first color is shown at the third viewpoint 3 under influence of the first color subpixel corresponding to the fourth viewpoint 4. The first color subpixel corresponding to the first viewpoint 1 and third color subpixel corresponding to the fifth viewpoint 5 spaced apart from the third viewpoint 3 may rarely influence the third viewpoint 3.

The display panel driver 300 may adjust grayscale data of the subpixels corresponding to the viewer's viewpoint detected by the viewpoint detecting part 400 and adjacent viewpoints of the viewer's viewpoint so that the display panel 100 may display an image corresponding to the viewer's viewpoint.

For example, if the viewer's left eye corresponds to the fourth viewpoint 4, the display panel driver 300 may adjust grayscale data of the first color subpixel corresponding to the fourth viewpoint 4 and grayscale data of the second color subpixel corresponding to the third viewpoint 3, which may be adjacent to the fourth viewpoint 4, and grayscale data of the third color subpixel corresponding to the fifth viewpoint 5, which may be adjacent to the fourth viewpoint 4, so that the display panel may display an image corresponding to the fourth viewpoint 4.

Alternatively, if the viewer's left eye has the fourth viewpoint 4, the display panel driver 300 may adjust grayscale data of the first color subpixel corresponding to the fourth viewpoint 4 and grayscale data of the subpixels corresponding to the second view point 2, the third view point 3, the fifth view point 5, and the sixth viewpoint 6 adjacent to the fourth viewpoint 4 so that the display panel may display an image corresponding to the fourth viewpoint 4.

In the second 3D pixel 3DP2, the first viewpoint 1 passes the central point or region of the second color subpixel so that the intensity of light having the second color may be above a reference value or strength.

In the third 3D pixel 3DP3, the first viewpoint 1 passes the central point or region of the third color subpixel so that the intensity of light having the third color may be above a reference value or strength.

As explained above, the first viewpoint 1 passes the central points or regions of the subpixels having colors different from one another. Accordingly, although the image corresponding to the viewpoint may not be accurate due to an error of the viewpoint detection and an error of the subpixel rendering, a likelihood of an occurrence of a color breakup may be reduced. For example, if the first color is shown to be stronger due to the above errors in the first 3D pixel 3DP1, the second color may correspondingly be shown stronger in the second 3D pixel 3DP2, and the third color may correspondingly be shown stronger in the third 3D pixel 3DP3. Thus, the likelihood of the color breakup being perceived by the viewer looking at an entire display panel 100 may be reduced.

FIG. 4 is a block diagram illustrating the display panel driver 300 of FIG. 1.

Referring to FIG. 1, FIG. 2, FIG. 3, and FIG. 4, the display panel driver 300 includes a timing controller 320, a gate driver 340 and a data driver 360.

The timing controller 320 includes a subpixel rendering part 322 and a signal generating part 324.

The subpixel rendering part 322 may receive input image data RGB from an external apparatus and a viewer's viewpoint VP from the viewpoint detecting part 400. The viewer's viewpoint VP may be a target viewpoint. The input image data RGB may include red image data R, green image data G, and blue image data B. The viewer's viewpoint VP may include a left viewpoint corresponding to the viewer's left eye and a right viewpoint corresponding to the viewer's right eye.

The subpixel rendering part 322 generates grayscale data DATA of the subpixel based on the input image data RGB and the viewer's viewpoint VP. The subpixel rendering part 322 generates grayscale data DATA corresponding to the viewer's viewpoint VP detected by the viewpoint detecting part 400 and viewpoints adjacent to the viewer's viewpoint VP.

The signal generating part 324 may receive input control signal CONT from an external apparatus. The input control signal CONT may include at least one of a master clock signal, a data enable signal, a vertical synchronizing signal and a horizontal synchronizing signal.

The signal generating part 324 generates a first control signal CONT1 to control an operation of the gate driver 340 based on the input control signal CONT. The signal generating part 324 outputs the first control signal CONT1 to the gate driver 340. The first control signal CONT1 may include at least one of a vertical start signal and a gate clock signal.

The signal generating part 324 generates a second control signal CONT2 to control an operation of the data driver 360 based on the input control signal CONT. The signal generating part 324 outputs the second control signal CONT2 to the data driver 360. The second control signal CONT2 may include at least one of a horizontal start signal and a load signal.

The timing controller 320 may further include an image compensating part to compensate the input image data RGB. The image compensating part may perform an adaptive color correction operation and a dynamic capacitance compensation operation to compensate the input image data RGB.

The gate driver 340 receives the first control signal CONT1 from the signal generating part 324. The gate driver 340 generates gate signals GS to drive the gate lines of the display panel 100 in response to the first control signal CONT1. The gate driver 340 may sequentially output the gate signals GS to the gate lines of the display panel 100.

The gate driver 340 may be mounted on the display panel 100. Alternatively, the gate driver 340 may be connected to the display panel 100 as a tape carrier package (“TCP”) type. Alternatively, the gate driver 340 may be integrated on the display panel 100.

The data driver 360 receives the second control signal CONT2 from the signal generating part 324 and the grayscale data DATA from the subpixel rendering part 322. The data driver 360 converts the grayscale data DATA into data voltages DV having analog types in response to the second control signal CONT2. The data driver 360 may sequentially output the data voltages DV to the data lines of the display panel 100.

The data driver 360 may be mounted on the display panel 100. Alternatively, the data driver 360 may be connected to the display panel 100 as a TCP type. Alternatively, the data driver 360 may be integrated on the display panel 100.

Further, the subpixel rendering part 322 may perform a rendering operation for a subpixel to generate a viewpoint image corresponding to viewer's viewpoint so that a resolution of the 3D image may be increased. In addition, the light converting axis of the light converting element 200 passes the central points or regions of the subpixels having colors different from one another so that a likelihood of the color breakup may be reduced or prevented. Thus, a display quality of the 3D image may be improved.

FIG. 5 is a plan view illustrating a pixel structure of a display panel 100A according to an exemplary embodiment of the present invention.

Referring to FIG. 5, the display panel 100A includes a plurality of subpixels. The subpixels are disposed in a matrix form.

The display panel 100A includes a plurality of 3D pixels 3DP1, 3DP2 and 3DP3. The subpixels in each of the 3D pixels 3DP1, 3DP2 and 3DP3 may respectively correspond to viewpoints different from one another.

The number of the viewpoints of the display apparatus may be a positive integer equal to or greater than six. In an example, the display apparatus may include twelve viewpoints to display the 3D image. Accordingly, each of the 3D pixels 3DP1, 3DP2 and 3DP3 may include twelve subpixels respectively corresponding to twelve viewpoints.

The directions of the viewpoints 1 to 12 may be similar or substantially equal to the light converting axis of the light converting element 200. The viewpoints 1 to 12 may pass central points or regions of the subpixels in the 3D pixels 3DP1, 3DP2 and 3DP3. The viewpoints 1 to 12 may be disposed in a uniform gap with one another. The subpixel may include a color different from a color of the subpixel corresponding to an adjacent viewpoint.

For example, a first 3D pixel 3DP1 may have twelve subpixels disposed in a substantially parallelogrammic shape. In the first 3D pixel 3DP1, a subpixel corresponding to a first viewpoint 1 may have the first color, a subpixel corresponding to a second viewpoint 2 adjacent to the first viewpoint 1 may have the third color, a subpixel corresponding to a third viewpoint 3 adjacent to the second viewpoint 2 may have the second color, a subpixel corresponding to a fourth viewpoint 4 adjacent to the third viewpoint 3 may have the first color, a subpixel corresponding to a fifth viewpoint 5 adjacent to the fourth viewpoint 4 may have the third color, a subpixel corresponding to a sixth viewpoint 6 adjacent to the fifth viewpoint 5 may have the second color, a subpixel corresponding to a seventh viewpoint 7 adjacent to the sixth viewpoint 6 may have the first color, a subpixel corresponding to an eighth viewpoint 8 adjacent to the seventh viewpoint 7 may have the third color, a subpixel corresponding to a ninth viewpoint 9 adjacent to the eighth viewpoint 8 may have the second color, a subpixel corresponding to a tenth viewpoint 10 adjacent to the ninth viewpoint 9 may have the first color, a subpixel corresponding to an eleventh viewpoint 11 adjacent to the tenth viewpoint 10 may have the third color, and a subpixel corresponding to a twelfth viewpoint 12 adjacent to the eleventh viewpoint 11 may have the second color.

The second 3D pixel 3DP2 may be disposed adjacent to the first 3D pixel 3DP1 along the light converting axis. The third 3D pixel 3DP3 may be disposed adjacent to the second 3D pixel 3DP2 along the light converting axis.

The light axis of the light converting element 200 may sequentially correspond to central points or regions of the subpixels having colors different from one another. For example, the first viewpoint 1 may pass a central point or region of the first color subpixel in the first 3D pixel 3DP1, a central point or region of the third color subpixel in the second 3D pixel 3DP2, and a central point or region of the second color subpixel in the third 3D pixel 3DP3.

A subpixel row of the display panel 100A may include the first color subpixel, the second color subpixel, and the third color subpixel alternately disposed with one another. An even-numbered subpixel row of the display panel 100A may be shifted by a width of the subpixel or a reference distance in the first direction D1 with respect to an odd-numbered subpixel row of the display panel 100A.

Further, the even-numbered subpixel row of the display panel 100A may be shifted by the width of the subpixel or a reference distance in the first direction D1 with respect to an odd-numbered subpixel row of the display panel 100A in a right direction.

The first color subpixels may be disposed in a zigzag pattern along the second direction D2. The second color subpixels may be disposed in a zigzag pattern along the second direction D2. The third color subpixels may be disposed in a zigzag pattern along the second direction D2.

Referring to FIG. 5, a width of each subpixel in the first direction D1 has a value of a. A width of each subpixel in the second direction D2 has a value of b. For example, a:b may be about 1:3.

Further, an absolute value of an inclination of the light converting axis may be 2b/a. The slope or inclination of the light converting axis may be 2b/a. In an example, if a:b is 1:3, the absolute value of the inclination of the light converting axis may be 6, and the inclination of the light converting axis may be 6.

The subpixel rendering part 322 of the display panel driver 300 may adjust grayscale data of the subpixels corresponding to the viewer's viewpoint detected by the viewpoint detecting part 400 and adjacent viewpoints of the viewer's viewpoint so that the display panel 100A may display an image corresponding to the viewer's viewpoint.

Further, the subpixel rendering part 322 may perform a rendering operation for a subpixel to generate a viewpoint image corresponding to viewer's viewpoint so that a resolution of the 3D image may be increased. In addition, the light converting axis of the light converting element 200 passes the central points or regions of the subpixels having colors different from one another so that a likelihood of the color breakup may be reduced. Thus, a display quality of the 3D image may be improved.

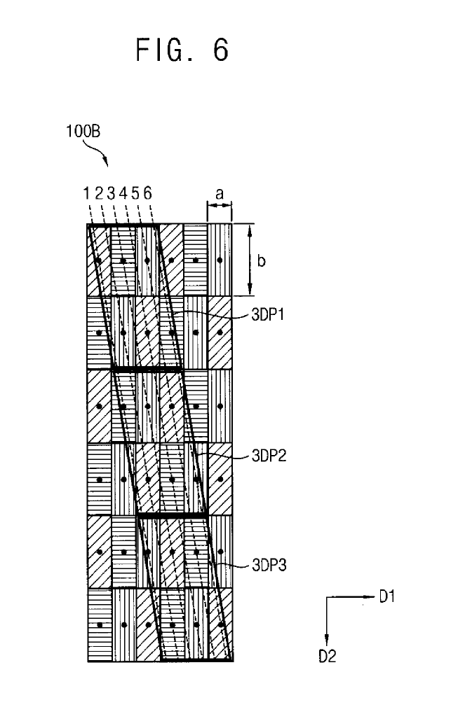

FIG. 6 is a plan view illustrating a pixel structure of a display panel 100B according to an exemplary embodiment of the present invention.

Referring to FIG. 6, the display panel 100B includes a plurality of subpixels. The subpixels are disposed in a matrix form.

The display panel 100B includes a plurality of 3D pixels 3DP1, 3DP2 and 3DP3. The subpixels in each of the 3D pixels 3DP1, 3DP2 and 3DP3 may respectively correspond to viewpoints different from one another.

The number of the viewpoints of the display apparatus may be a positive integer equal to or greater than six. In an example, the display apparatus may include six viewpoints to display the 3D image. Accordingly, each of the 3D pixels 3DP1, 3DP2 and 3DP3 may include six subpixels respectively corresponding to six viewpoints.

The directions of the viewpoints 1 to 6 may be similar or substantially equal to the light converting axis of the light converting element 200. The viewpoints 1 to 6 may pass central points or regions of the subpixels in the 3D pixels 3DP1, 3DP2 and 3DP3. The viewpoints 1 to 6 may be disposed in a uniform gap with one another. The subpixel may include a color different from a color of the subpixel corresponding to an adjacent viewpoint.

For example, a first 3D pixel 3DP1 may have six subpixels disposed in a substantially parallelogrammic shape. In the first 3D pixel 3DP1, a subpixel corresponding to a first viewpoint 1 may have the first color, a subpixel corresponding to a second viewpoint 2 adjacent to the first viewpoint 1 may have the third color, a subpixel corresponding to a third viewpoint 3 adjacent to the second viewpoint 2 may have the second color, a subpixel corresponding to a fourth viewpoint 4 adjacent to the third viewpoint 3 may have the first color, a subpixel corresponding to a fifth viewpoint 5 adjacent to the fourth viewpoint 4 may have the third color, and a subpixel corresponding to a sixth viewpoint 6 adjacent to the fifth viewpoint 5 may have the second color.

The second 3D pixel 3DP2 may be disposed adjacent to the first 3D pixel 3DP1 along the light converting axis. The third 3D pixel 3DP3 may be disposed adjacent to the second 3D pixel 3DP2 along the light converting axis.

The light axis of the light converting element 200 may sequentially correspond to central points or regions of the subpixels having colors different from one another. For example, the first viewpoint 1 passes a central point or region of the first color subpixel in the first 3D pixel 3DP1, a central point or region of the second color subpixel in the second 3D pixel 3DP2, and a central point or region of the third color subpixel in the third 3D pixel 3DP3.

A subpixel row of the display panel 100B may include the first color subpixel, the second color subpixel and the third color subpixel alternately disposed with one another. An even-numbered subpixel row of the display panel 100B may be shifted by a width of the subpixel in the first direction D1 with respect to an odd-numbered subpixel row of the display panel 100B.

Further, the even-numbered subpixel row of the display panel 100B may be shifted by the width of the subpixel in the first direction D1 with respect to an odd-numbered subpixel row of the display panel 100B in a left direction.

The first color subpixels may be disposed in a zigzag pattern along the second direction D2. The second color subpixels may be disposed in a zigzag pattern along the second direction D2. The third color subpixels may be disposed in a zigzag pattern along the second direction D2.

Referring to FIG. 6, a width of each subpixel in the first direction D1 has a value of a. A width of each subpixel in the second direction D2 has a value of b. For example, a:b may be about 1:3.

Further, an absolute value of an inclination of the light converting axis may be 2b/a. The slope or inclination of the light converting axis may be −2b/a. In an example, if a:b is 1:3, the absolute value of the inclination of the light converting axis may be 6, and the inclination of the light converting axis may be −6.

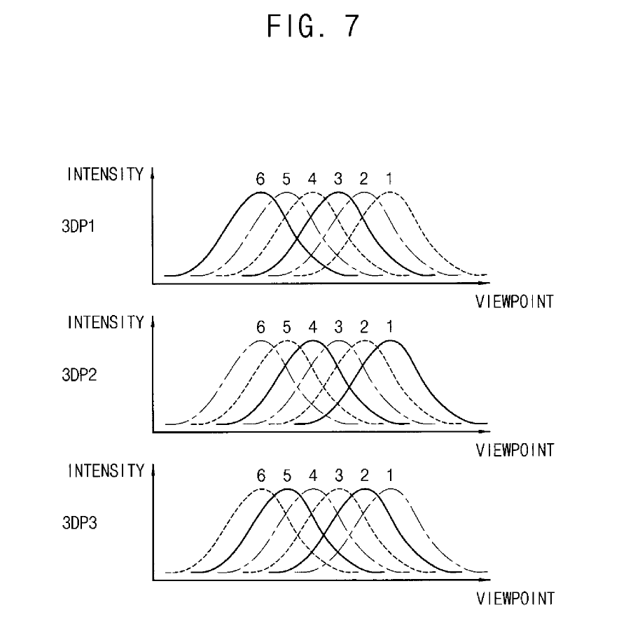

FIG. 7 is a graph illustrating an intensity of a light passing the subpixel of FIG. 6 with respect to viewpoints if same data voltage is applied to the subpixels corresponding to each of the viewpoints according to an exemplary embodiment of the present invention.

Referring to FIG. 6 and FIG. 7, in the first 3D pixel 3DP1, the first viewpoint 1 may pass the central point or region of the first color subpixel so that the intensity of light having the first color may be above a reference value or strength. Light having the third color is shown at the first viewpoint 1 under influence of the third color subpixel corresponding to the second viewpoint 2. The second color subpixel corresponding to the third viewpoint 3, which may be spaced apart from the first viewpoint 1, may rarely influence the first viewpoint 1. Although not shown in FIG. 3, light having the second color may be shown at the first viewpoint 1 under influence of the second color subpixel corresponding to the twelfth viewpoint 12 of another 3D pixel.

In the first 3D pixel 3DP1, the second viewpoint 2 passes the central point or region of the third color subpixel so that the intensity of light having the third color may be above a reference value or strength. Light having the first color is shown at the second viewpoint 2 under influence of the first color subpixel corresponding to the first viewpoint 1. Light having the second color is shown at the second viewpoint 2 under influence of the second color subpixel corresponding to the third viewpoint 3. The first color subpixel corresponding to the fourth viewpoint 4 spaced apart from the second viewpoint 2 may rarely influence the second viewpoint 2.

The subpixel rendering part 322 of the display panel driver 300 may adjust grayscale data of the subpixels corresponding to the viewer's viewpoint detected by the viewpoint detecting part 400 and adjacent viewpoints of the viewer's viewpoint so that the display panel 100B may display an image corresponding to the viewer's viewpoint.

Further, the subpixel rendering part 322 may perform a rendering operation for a subpixel to generate a viewpoint image corresponding to viewer's viewpoint so that a resolution of the 3D image may be increased. In addition, the light converting axis of the light converting element 200 passes the central points or regions of the subpixels having colors different from one another so that a likelihood of the color breakup may be reduced or prevented. Thus, a display quality of the 3D image may be improved.

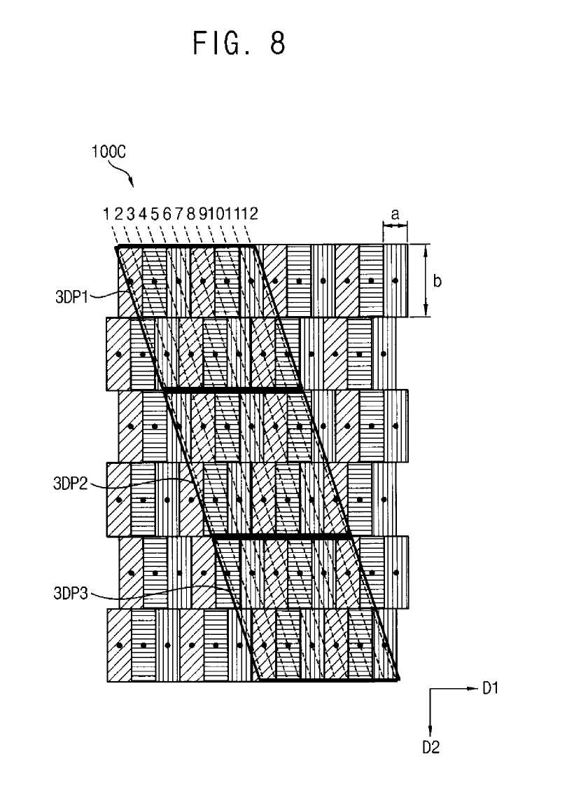

FIG. 8 is a plan view illustrating a pixel structure of a display panel 100C according to an exemplary embodiment of the present invention.

Referring to FIG. 8, the display panel 100C includes a plurality of subpixels. The subpixels are disposed in a matrix form.

The display panel 100C includes a plurality of 3D pixels 3DP1, 3DP2 and 3DP3. The subpixels in each of the 3D pixels 3DP1, 3DP2 and 3DP3 may respectively correspond to viewpoints different from one another.

The number of the viewpoints of the display apparatus may be a positive integer equal to or greater than six. In an example, the display apparatus may include twelve viewpoints to display the 3D image. Accordingly, each of the 3D pixels 3DP1, 3DP2 and 3DP3 may include twelve subpixels respectively corresponding to twelve viewpoints.

The directions of the viewpoints 1 to 12 may be similar or substantially equal to the light converting axis of the light converting element 200. The viewpoints 1 to 12 may pass central points or regions of the subpixels in the 3D pixels 3DP1, 3DP2 and 3DP3. The viewpoints 1 to 12 may be disposed in a uniform gap with one another. The subpixel may include a color different from a color of the subpixel corresponding to an adjacent viewpoint.

For example, a first 3D pixel 3DP1 may have twelve subpixels disposed in a substantially parallelogrammic shape. In the first 3D pixel 3DP1, a subpixel corresponding to a first viewpoint 1 may have the first color, a subpixel corresponding to a second viewpoint 2 adjacent to the first viewpoint 1 may have the third color, a subpixel corresponding to a third viewpoint 3 adjacent to the second viewpoint 2 may have the second color, a subpixel corresponding to a fourth viewpoint 4 adjacent to the third viewpoint 3 may have the first color, a subpixel corresponding to a fifth viewpoint 5 adjacent to the fourth viewpoint 4 may have the third color, a subpixel corresponding to a sixth viewpoint 6 adjacent to the fifth viewpoint 5 may have the second color, a subpixel corresponding to a seventh viewpoint 7 adjacent to the sixth viewpoint 6 may have the first color, a subpixel corresponding to an eighth viewpoint 8 adjacent to the seventh viewpoint 7 may have the third color, a subpixel corresponding to a ninth viewpoint 9 adjacent to the eighth viewpoint 8 may have the second color, a subpixel corresponding to a tenth viewpoint 10 adjacent to the ninth viewpoint 9 may have the first color, a subpixel corresponding to an eleventh viewpoint 11 adjacent to the tenth viewpoint 10 may have the third color, and a subpixel corresponding to a twelfth viewpoint 12 adjacent to the eleventh viewpoint 11 may have the second color.

The second 3D pixel 3DP2 may be disposed adjacent to the first 3D pixel 3DP1 along the light converting axis. The third 3D pixel 3DP3 may be disposed adjacent to the second 3D pixel 3DP2 along the light converting axis.

The light axis of the light converting element 200 may sequentially correspond to central points or regions of the subpixels having colors different from one another. For example, the first viewpoint 1 passes a central point or region of the first color subpixel in the first 3D pixel 3DP1, a central point or region of the third color subpixel in the second 3D pixel 3DP2, and a central point or region of the second color subpixel in the third 3D pixel 3DP3.

A subpixel row of the display panel 100C may include the first color subpixel, the second color subpixel, and the third color subpixel alternately disposed with one another. An even-numbered subpixel row of the display panel 100C may be shifted by a half of a width of the subpixel in the first direction D1 with respect to an odd-numbered subpixel row of the display panel 100C.

Further, the even-numbered subpixel row of the display panel 100C may be shifted by the half of the width of the subpixel in the first direction D1 with respect to an odd- numbered subpixel row of the display panel 100C in a left direction.

The first color subpixels may be disposed in a zigzag pattern along the second direction D2. The second color subpixels may be disposed in a zigzag pattern along the second direction D2. The third color subpixels may be disposed in a zigzag pattern along the second direction D2.

Referring to FIG. 8, a width of each subpixel in the first direction D1 has a value of a. A width of each subpixel in the second direction D2 has a value of b. For example, a:b may be about 1:3.

Further, an absolute value of an inclination of the light converting axis may be b/a. The slope or inclination of the light converting axis may be −b/a. In an example, if a:b is 1:3, the absolute value of the inclination of the light converting axis may be 3, and the inclination of the light converting axis may be −3.

The subpixel rendering part 322 of the display panel driver 300 may adjust grayscale data of the subpixels corresponding to the viewer's viewpoint detected by the viewpoint detecting part 400 and adjacent viewpoints of the viewer's viewpoint so that the display panel 100C may display an image corresponding to the viewer's viewpoint.

Further, the subpixel rendering part 322 performs a rendering operation for a subpixel to generate a viewpoint image corresponding to viewer's viewpoint so that a resolution of the 3D image may be increased. In addition, the light converting axis of the light converting element 200 passes the central points or regions of the subpixels having colors different from one another so that a likelihood of the color breakup may be reduced. Thus, a display quality of the 3D image may be improved.

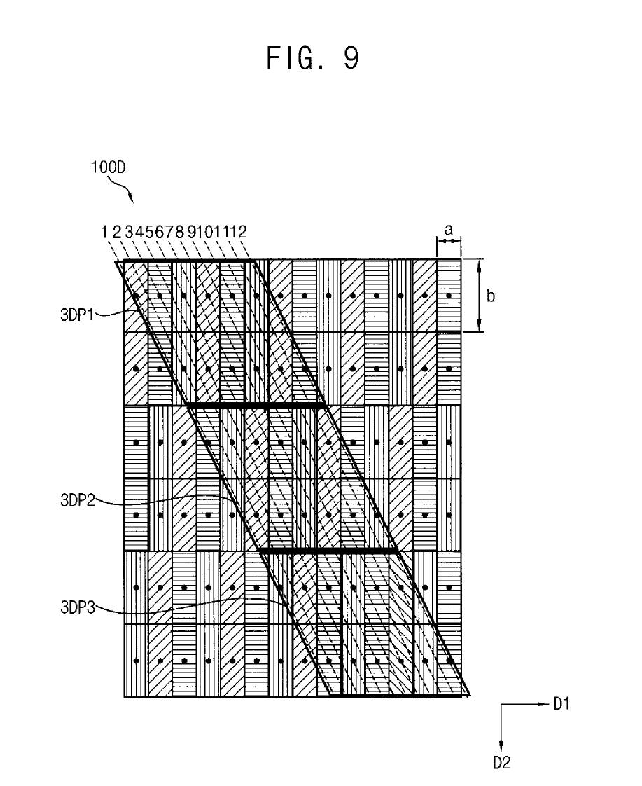

FIG. 9 is a plan view illustrating a pixel structure of a display panel 100D according to an exemplary embodiment of the present invention.

Referring to FIG. 9, the display panel 100D includes a plurality of subpixels. The subpixels are disposed in a matrix form.

The display panel 100D includes a plurality of 3D pixels 3DP1, 3DP2 and 3DP3. The subpixels in each of the 3D pixels 3DP1, 3DP2 and 3DP3 may respectively correspond to viewpoints different from one another.

The number of the viewpoints of the display apparatus may be a positive integer equal to or greater than six. In an example, the display apparatus may include twelve viewpoints to display the 3D image. Accordingly, each of the 3D pixels 3DP1, 3DP2 and 3DP3 may include twelve subpixels respectively corresponding to twelve viewpoints.

The directions of the viewpoints 1 to 12 may be similar or substantially equal to the light converting axis of the light converting element 200. The viewpoints 1 to 12 may pass central points or regions of the subpixels in the 3D pixels 3DP1, 3DP2 and 3DP3. The viewpoints 1 to 12 may be disposed with a uniform gap present between the viewpoints. The subpixel may include a color different from a color of the subpixel corresponding to an adjacent viewpoint.

For example, a first 3D pixel 3DP1 may have twelve subpixels disposed in a substantially parallelogrammic shape. In the first 3D pixel 3DP1, a subpixel corresponding to a first viewpoint 1 may have the first color, a subpixel corresponding to a second viewpoint 2 adjacent to the first viewpoint 1 may have the third color, a subpixel corresponding to a third viewpoint 3 adjacent to the second viewpoint 2 may have the second color, a subpixel corresponding to a fourth viewpoint 4 adjacent to the third viewpoint 3 may have the first color, a subpixel corresponding to a fifth viewpoint 5 adjacent to the fourth viewpoint 4 may have the third color, a subpixel corresponding to a sixth viewpoint 6 adjacent to the fifth viewpoint 5 may have the second color, a subpixel corresponding to a seventh viewpoint 7 adjacent to the sixth viewpoint 6 may have the first color, a subpixel corresponding to an eighth viewpoint 8 adjacent to the seventh viewpoint 7 may have the third color, a subpixel corresponding to a ninth viewpoint 9 adjacent to the eighth viewpoint 8 may have the second color, a subpixel corresponding to a tenth viewpoint 10 adjacent to the ninth viewpoint 9 may have the first color, a subpixel corresponding to an eleventh viewpoint 11 adjacent to the tenth viewpoint 10 may have the third color, and a subpixel corresponding to a twelfth viewpoint 12 adjacent to the eleventh viewpoint 11 may have the second color.

The second 3D pixel 3DP2 may be disposed adjacent to the first 3D pixel 3DP1 along the light converting axis. The third 3D pixel 3DP3 may be disposed adjacent to the second 3D pixel 3DP2 along the light converting axis.

The light axis of the light converting element 200 may sequentially correspond to central points or regions of the subpixels having colors different from one another. For example, the first viewpoint 1 passes a central point or region of the first color subpixel in the first 3D pixel 3DP1, a central point or region of the third color subpixel in the second 3D pixel 3DP2 and a central point or region of the second color subpixel in the third 3D pixel 3DP3.

A subpixel row of the display panel 100D may include the first color subpixel, the second color subpixel, and the third color subpixel alternately disposed with one another.

A first subpixel row and a second subpixel row of the display panel 100D may include subpixels having same color alignment as each other. A third subpixel row and a fourth subpixel row of the display panel 100D may include subpixels having same color alignment as each other. A fifth subpixel row and a sixth subpixel row of the display panel 100D may include subpixels having same color alignment as each other.

The third subpixel row and the fourth subpixel row may be shifted by a width of the subpixel or a reference distance in the first direction D1 with respect to the first subpixel row and the second subpixel row. The fifth subpixel row and the sixth subpixel row may be shifted by the width of the subpixel or a reference distance in the first direction D1 with respect to the third subpixel row and the fourth subpixel row.

Further, the third subpixel row and the fourth subpixel row are shifted by the width of the subpixel in the first direction D1 with respect to the first subpixel row and the second subpixel row in a left direction. The fifth subpixel row and the sixth subpixel row are shifted by the width of the subpixel in the first direction D1 with respect to the third subpixel row and the fourth subpixel row in the left direction.

Referring to FIG. 9, a width of each subpixel in the first direction D1 has a value of a. A width of each subpixel in the second direction D2 has a value of b. For example, a:b may be about 1:3.

Further, an absolute value of an inclination or a slope of the light converting axis may be 2b/3a. The slope or inclination of the light converting axis may be −2b/3a. In an example, if a:b is 1:3, the absolute value of the inclination or the slope of the light converting axis may be 2, and the inclination of the light converting axis may be −2.

The subpixel rendering part 322 of the display panel driver 300 may adjust grayscale data of the subpixels corresponding to the viewer's viewpoint detected by the viewpoint detecting part 400 and adjacent viewpoints of the viewer's viewpoint so that the display panel 100D may display an image corresponding to the viewer's viewpoint.

Further, the subpixel rendering part 322 may perform a rendering operation for a subpixel to generate a viewpoint image corresponding to viewer's viewpoint so that a resolution of the 3D image may be increased. In addition, the light converting axis of the light converting element 200 passes the central points or regions of the subpixels having colors different from one another so that a likelihood of the color breakup may be reduced. Thus, a display quality of the 3D image may be improved.

As explained above, a display apparatus and a method for displaying the 3D image according to exemplary embodiments of the present invention, may increase resolution and reduce color breakup so that a display quality of the 3D image may be improved.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means- plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A display apparatus, comprising:
a display panel comprising a first three-dimensional (“3D”) pixel, a second 3D pixel, and a third 3D pixel, wherein each 3D pixel comprises a first subpixel, a second subpixel, and a third subpixel corresponding to a plurality of viewpoints;
a viewpoint detecting part configured to detect a target viewpoint;
a display panel driver configured to generate grayscale data of the subpixels based on the target viewpoint; and
a light converting element comprising a light converting axis sequentially corresponding to central regions of the subpixels comprising colors different from one another and configured to convert an image on the display panel into a 3D image.

2. The display apparatus of claim 1, wherein the second 3D pixel is disposed adjacent to the first 3D pixel along the light converting axis, and the third 3D pixel is disposed adjacent to the second 3D pixel along the light converting axis, and
the light converting axis is oriented in parallel to an imaginary line that connects a central region of the first subpixel corresponding to a first viewpoint in the first 3D pixel, a central region of the second subpixel corresponding to the first viewpoint in the second 3D pixel, and a central region of the third subpixel corresponding to the first viewpoint in the third 3D pixel.

3. The display apparatus of claim 2, wherein the first subpixel comprises a first color,
the second subpixel comprises a second color, and
the third subpixel comprises a third color.

4. The display apparatus of claim 3, wherein the first color is red,
the second color is green, and
the third color is blue.

5. The display apparatus of claim 1, wherein a subpixel row of the display panel comprises the first subpixel comprising a first color, the second subpixel comprising a second color, and the third subpixel comprising a third color, and
wherein the first subpixel, the second subpixel, and the third subpixel are alternately disposed with one another in the subpixel row.

6. The display apparatus of claim 5, wherein
an even-numbered subpixel row of the display panel is shifted by a reference distance in a first direction with respect to an odd-numbered subpixel row of the display panel.

7. The display apparatus of claim 6, wherein
the reference distance comprises a range of a half of a width to a whole width of one of the subpixels.

8. The display apparatus of claim 6, wherein an absolute value of an inclination of the light converting axis corresponds to twice a length of one of the subpixels divided by a width of one of the subpixels, if the reference distance is equal to the whole width of one of the subpixels.

9. The display apparatus of claim 6, wherein an absolute value of an inclination of the light converting axis corresponds to a length of one of the subpixels divided by a width of one of the subpixels, if the reference distance is equal to half the width of one of the subpixels.

10. The display apparatus of claim 5, wherein
a first subpixel row and a second subpixel row of the display panel comprise the subpixels arranged in a first order, a third subpixel row and a fourth subpixel row of the display panel comprise subpixels arranged in a second order, and a fifth subpixel row and a sixth subpixel row of the display panel comprise subpixels arranged in a third order,
the third subpixel row and the fourth subpixel row are shifted by a width of one of the subpixels in a first direction with respect to the first subpixel row and the second subpixel row, and
the fifth subpixel row and the sixth subpixel row are shifted by a width of one of the subpixels in the first direction with respect to the third subpixel row and the fourth subpixel row.

11. The display apparatus of claim 10, wherein an absolute value of an inclination of the light converting axis is 2b/3a if a width of one of the subpixels in the first direction is a and a length of one of the subpixel in a second direction is b.

12. The display apparatus of claim 1, wherein the display panel driver is configured to generate the grayscale data of the subpixels corresponding to the target viewpoint and adjacent viewpoints.

13. The display apparatus of claim 1, wherein a number of the viewpoints is a positive integer equal to or greater than six.

14. The display apparatus of claim 1, wherein the light converting element comprises a lens module or a barrier module configured to operate according to a driving mode, the driving mode comprising a two-dimensional mode and a 3D mode.

15. A method for displaying a three-dimensional (“3D”) image on a display panel, the method comprising:
detecting a target viewpoint;
generating grayscale data for a first subpixel, a second subpixel, and a third subpixel corresponding to a plurality of viewpoints based on the target viewpoint; and
converting an image on a display panel into a 3D image using a light converting element comprising a light converting axis sequentially corresponding to central regions of the subpixels comprising colors different from one another.

16. The method of claim 15, wherein the display panel comprises a first 3D pixel, a second 3D pixel adjacent to the first 3D pixel along the light converting axis, and a third 3D pixel adjacent to the second 3D pixel along the light converting axis,
the light converting axis is oriented parallel to an imaginary line connecting a central region of the first subpixel corresponding to a first viewpoint in the first 3D pixel, a central region of the second subpixel corresponding to the first viewpoint in the second 3D pixel, and a central region of the third subpixel corresponding to the first viewpoint in the third 3D pixel.

17. The method of claim 16, wherein the first subpixel comprises a first color,
the second subpixel comprises a second color, and
the third subpixel comprises a third color.

18. The method of claim 17, wherein the first color is red,
the second color is green, and
the third color is blue.

19. The method of claim 15, wherein the generating grayscale data of subpixels comprises generating the grayscale data of the subpixels corresponding to the target viewpoint and adjacent viewpoints.

20. The method of claim 15, wherein the light converting element comprises a lens module or a barrier module configured to operate according to a driving mode, the driving mode comprising a two-dimensional mode and a 3D mode.

21. The method of claim 15, wherein a number of the viewpoints is a positive integer equal to or greater than six.

22. A display apparatus, comprising:
a display panel comprising a three-dimensional (“3D”) pixel, the 3D pixel comprising a plurality of subpixels comprising different colors;
a viewpoint detecting part configured to detect a target viewpoint; and
a display panel driver configured to generate grayscale data of the subpixels based on the target viewpoint,
wherein the target viewpoint corresponds to a light converting axis passing through central regions of at least three subpixels of different colors.
